(19) United States
(12) Patent Application Publication
(10) Pub. No.: US 2007/0280415 A1
(43) Pub. Date: Dec. 6, 2007

(54) Method of and apparatus for measuring the thickness of moving metal sheet articles

(76) Inventor: Keith Waterson, Kingston (CA)

Correspondence Address: Christopher C. Dunham;c/o Cooper & Dunham LLP, 1185 Ave. of the Americas, New York, NY, 10036, US

(21) Appl. No.: 11/444,611

(22) Filed: May 31, 2006

(51) Int. Cl. G01B 15/02; G01N 23/06

(52) U.S. Cl. 378/55

(57) ABSTRACT

A method of and apparatus for measuring the true thickness, as well as angles of orientation, of a strip article, e.g. a moving metal sheet emerging from a rolling apparatus. The thickness and angles are measured by three penetrating radiation beams (e.g. X-rays) that cross at a common point of intersection, generally but not necessarily, within the body of the sheet article. One beam is generally normal to the sheet article and the others are oriented in the longitudinal and transverse directions of the sheet article. The angles between the beams are generally fixed and known. -The thicknesses measured by the three beams can be used, along with their respective angles of orientation, to calculate the true thickness of the sheet article as well as the angles of sag or off-flatness in the transverse and longitudinal directions at the point of measurement. By measuring these values at various points on the strip article, a thickness and orientation profile of the strip article may be produced.

### BACKGROUND OF THE INVENTION

1. Field of the Invention

This invention relates to the measurement of the thickness and/or angles of slope of moving metal sheet articles. More particularly, the invention relates to such measurements carried out by means of metal-penetrating radiation, such as X-rays or ionizing radiation.

2. Background Art

In metal rolling operations for the production of sheet articles in rolling mills and the like, there is a need to measure the thickness of emerging metal sheets to ensure that the sheet thickness remains uniform and within established limits. Such measurements ideally have to be carried out without stopping the rolling operation and have to yield measurements quickly. One way of achieving this is to make use of metal-penetrating radiation, primarily X-rays, whereby the attenuation of a radiation beam as it passes through the metal can be used as a measure of the thickness of the sheet article. A radiation source may be positioned on one side of a moving sheet article and a radiation detector positioned on the opposite side. The strength of the radiation detected by the radiation detector may then be compared (e.g. by computer) with reference values obtained earlier from sheet articles of known thickness, or from known X-ray attenuation coefficients for the metal alloy of the sheet article, and the thickness of the moving sheet article can then be established on an almost-instantaneous basis. If the radiation source-detector pair can be moved transversely of the direction of movement of the sheet article, thickness values across the width of the sheet article can be observed.

A device for carrying out such a method is disclosed in U.S. Pat. No. 3,715,592 issued on Feb. 6, 1973 to Edward R. Busch et al. This device uses two collimated beams of radiation, namely a prime radiation beam and a scanning beam, which are tilted in opposite directions relative to the plane of the longitudinally moving metal strip article to provide clearance for the radiation sources and associated detectors during their traverse across the width of the strip. The tilted beams enable the relative change in strip thickness to be measured at essentially the same longitudinal position.

U.S. Pat. No. 6,480,802 which issued to Paul Flormann on Nov. 12, 2002 discloses a method of determining the flatness of a strip article. The method employs radiation sources and detectors to measure the changes of slope values at a plurality of measurement points, and the slopes are summed to calculate the strip contour.

A problem of carrying out measurements by means of transversely-moving pairs of radiation sources and detectors on sheet articles produced in rolling mills, especially hot rolling mills for aluminum sheet, is that the articles often experience sag (a bowing of the sheet in the transverse direction) and a lack of flatness (undulation in the longitudinal direction) as the sheet article emerges from between the rollers. Such deviations from the ideal flat (planar) condition cause inaccuracies in the thickness measurement when radiation devices are employed. The thickness of the sheet at any point is the spacing between the opposite surfaces measured at right angles to the surfaces. However, if the sheet article is not orientated at right angles to the beam of radiation at each point of measurement, the beam will pass through the sheet at non-normal angle to the surfaces and thus through a greater amount of metal than the true thickness. Therefore, an incorrect reading will be provided. There is therefore a need for a method and apparatus for obtaining a more accurate reading in such conditions.

### SUMMARY OF THE INVENTION

An exemplary embodiment of the present invention provides a method of determining an actual thickness of sheet article or angles of off-flatness thereof at a point of measurement of the article. The method comprises providing three pairs of sources and detectors of radiation capable of penetrating the sheet article, the source and detector of each pair being spaced from each other along a longitudinal axis, disposing the three pairs of radiation sources and detectors in two intersecting planes orientated at right angles to one another, such that one of the pairs is common to both planes at an intersection-of the planes, angling the respective pairs of radiation sources and detectors with respect to each other at known angles and such that the longitudinal axes of all three pairs intersect, preferably at a common point of intersection between each of the sources and detectors, disposing a sheet article between the sources and detectors of each pair, preferably such that the common point of intersection falls within the sheet article at the point of measurement, operating the radiation sources to generate radiation and obtaining an output value from the detectors of each pair corresponding to a detected thickness of the sheet article along each the axis; and calculating an actual thickness of the sheet article at the point of measurement from the values obtained from the three radiation detectors and from the known angles, regardless of the orientation of the sheet article at the point of measurement.

The method may make use of suitable penetrating radiation capable of being used for thickness measurements, e.g. X-ray radiation or ionizing radiation. If possible, the beams of radiation generated by the radiation sources should be collimated.

After performing the calculation for the position on the sheet article at the point of measurement, the sheet article and the mutually aligned pairs of radiation sources and detectors may be moved relative to each other so that a thickness calculation may be carried out at other points of measurement on the sheet article, and, if desired, the method may be operated to provide an alignment profile of the sheet article at the respective points of measurement.

Normally, the sheet article is elongated and is moved longitudinally between the sources and detectors of radiation, e.g. as the sheet article exits a rolling mill or the like.

In another exemplary embodiment, the present invention provides a method of measuring a true thickness, as well as angles of off-flatness, of a moving strip article. The method comprises providing a sheet article moving in a longitudinal direction, generating three beams of sheet-article-penetrating radiation that cross each other at known angles (preferably at a common point of intersection), disposing the beams and sheet article such that the beams pass through the strip article with one beam generally normal to the sheet article and the other beams respectively oriented in the longitudinal direction and a direction transverse to the longitudinal direction, obtaining an indication of strength of the beams after passing through the sheet article at a point of measurement, and calculating a true thickness of the article at the point of measurement and optionally angles of off-flatness of the strip article in the longitudinal and transverse directions.

In another exemplary embodiment, the present invention provides a method of measuring thickness or off-flatness of an elongated strip article as said strip article is being advanced longitudinally in a direction of advancement, which method comprises passing penetrating radiation through the strip article, measuring attenuation of the radiation passing through the strip article, and calculating the thickness or off-flatness of the strip article from the measured attenuation, wherein attenuation of three beams of said radiation intersecting at a common point is measured at the same time, a first of said beams being disposed generally at right angles to the direction of advancement, a second beam being rotated at an angle to the first beam in the direction of advancement of the strip article and a third beam being rotated at an angle to the first beam in a direction transverse to the direction of advancement of the strip article. The term “generally at right angles” means that the beam in question is normal (90°±5°, more preferably 90°±1°) to the plane of strip when the strip is moved along the intended direction of advancement.

In another exemplary embodiment, the present invention provides apparatus for determining an actual thickness of sheet article or angles of off-flatness thereof at a point of measurement of the sheet article, the apparatus comprising: three pairs of sources and detectors of radiation capable of penetrating the sheet article, the source and detector of each pair being spaced from each other along a longitudinal axis, the three pairs of radiation sources and detectors being disposed in two intersecting planes orientated at right angles to one another, such that one of the pairs is common to both planes at an intersection of the planes, the three pairs of radiation sources and detectors being angled with respect to each other at known angles and such that the longitudinal axes of all three pairs intersect at a common point of intersection between each of the sources and detectors, a holder for holding the three pairs of radiation sources and detectors with the sources and detectors disposed on opposite sides of a sheet article positioned between the sources and detectors of each pair, preferably such that the common point of intersection falls within the sheet article at the point of measurement, a receiver for receiving output values from the detectors of each pair corresponding to a detected thickness of the sheet article along each axis; and calculator for calculating an actual thickness of the sheet article at the point of measurement from the output values received from the three radiation detectors and from the known angles, regardless of the orientation of the sheet article at the point of measurement.

In yet another exemplary embodiment, the invention provides apparatus for measuring thickness or off-flatness of a strip article as said article is being advanced longitudinally in a direction of advancement, said apparatus including aligned pairs of sources and detectors of penetrating radiation positioned to measure attenuation of beams of radiation passing through the strip article, and a calculator for calculating thickness or off-flatness of the strip article from the measured attenuation, wherein the apparatus has three pairs of said sources and detectors positioned and operable to measure attenuation of three beams radiation intersecting at a common point at the same time, a first pair disposed generally at right angles to the direction of advancement of the strip article, a second pair being rotated at an angle to the first pair in the direction of advancement, and a third pair being rotated at an angle to the first pair in a direction transverse to the direction of advancement of the strip article.

The apparatus preferably has a structure that allows the radiation sources and detectors to be moved transversely fully across the width of the sheet article, and the calculator is preferably a computer provided with an appropriate program for calculation of the thickness and alignment of the sheet article at the points of measurement.

### BRIEF DESCRIPTION OF THE DRAWINGS

FIG. 1 is cross-section of one form of a measuring apparatus according to the present invention showing a strip article in transverse cross-section;

FIG. 2 is a cross-section of the apparatus of FIG. 1, showing a longitudinal side view of a strip article;

FIG. 3 is a horizontal cross-section of the apparatus of FIG. 1, showing the upper side of a strip article;

FIG. 4 is an illustration of crossing planes showing the arrangement of source and detector pairs in the present invention;

FIG. 5 is a detailed longitudinal section showing isolated parts of the apparatus;

FIG. 6 is a detailed view similar to FIG. 4, but showing a transverse section; and

FIGS. 7 to 14 are graphs showing features and results explained in the Example set out below.

### DETAILED DESCRIPTION OF THE PREFERRED EMBODIMENTS

First of all, it should be noted that the term “off-flatness” as used in this description is intended as a generic term to cover sheet article “sag” (off-flatness in the direction transverse to the direction of advancement (rolling direction) of the sheet article) and also “lack of flatness” (undulation in the direction of advancement (rolling direction) of the sheet article).

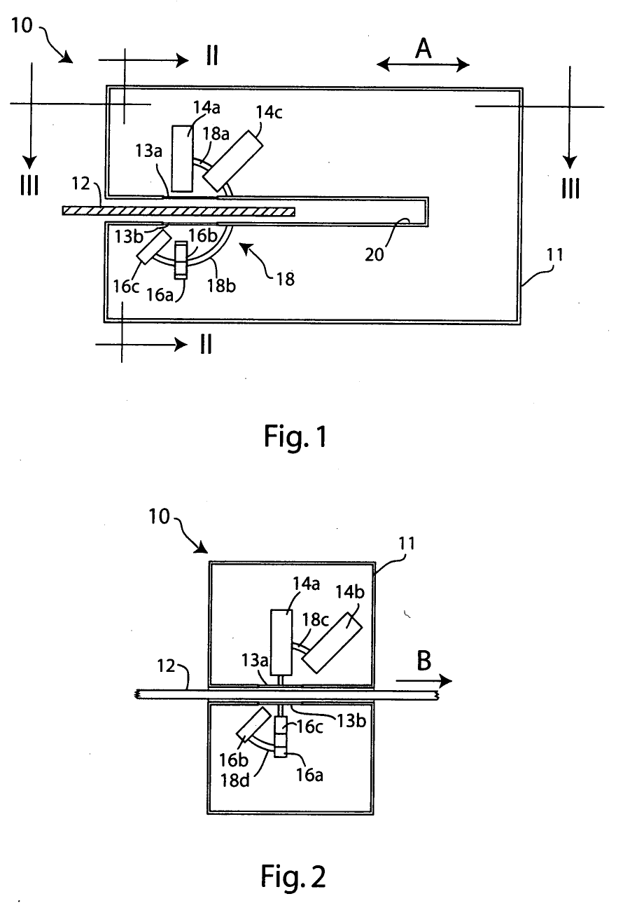

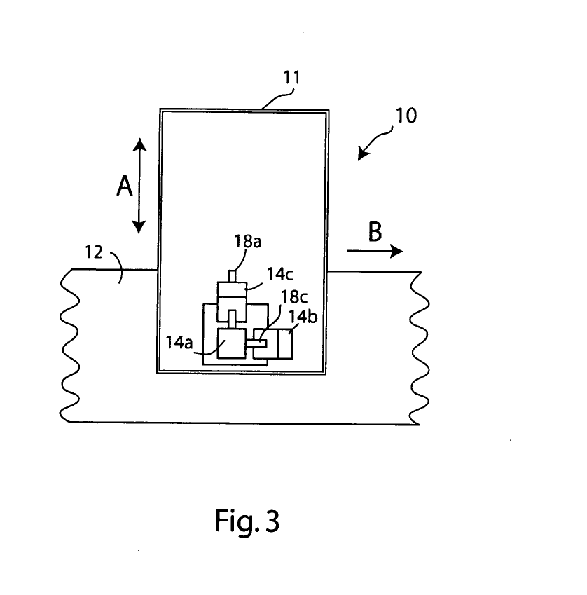

A device 10 according to one form of the present invention is shown in FIGS. 1 to 3 of the accompanying drawings. The device is in the form of a movable ‘C’ frame unit 11 that may be moved transversely across a sheet article 12 as represented by double-headed arrow A. The sheet article may be, for example, a metal strip emerging from a rolling operation designed to reduce the thickness of the strip. The sheet article 12 is shown in cross-section in FIG. 1, in side view in FIG. 2 and in top plan view in FIG. 3, and the direction of advancement of the sheet article is indicated by arrow B in FIGS. 2 and 3. The device 10 includes three radiation sources 14a, 14b and 14c arranged above the sheet article 12, and three radiation detectors 16a, 16b and 16c arranged below the sheet article 12 (of course, this arrangement could be reversed, with the radiation detectors all positioned above the sheet article 12 and the radiation sources all positioned below, or there could be a mixture with some sources/detectors above and some below). The radiation beams produced by the sources are preferably collimated and are of a kind that can penetrate the strip article with a degree of attenuation that is related to the thickness of the article through which the radiation passes. X-ray radiation is preferred for this purpose but other forms of penetrating radiation (e.g. ionizing radiation produced by radioactive isotopes) may alternatively be employed.

The C-frame unit 11 acts as a housing for the radiation sources and detectors and, in this embodiment, is provided with radiation windows 13a and 13b that allow the radiation to leave and enter the housing with a low level of controlled attenuation. When the radiation consists of X-rays, the windows may take the form of thin metal, preferably aluminum, sheets to protect the detectors and sources from ingress of material from the rolling process. For ionizing radiation (isotope gauges), the windows 13a and 13b may be shutters that can be slid open and closed, and that are radiation absorbers so that there is no significant emission of radiation when the shutters are closed. This difference reflects the facts that X-ray radiation can be turned on and off as required, but this is not true of ionizing radiation produced by radio-active isotopes.

All of the sources and detectors are held in place relative to each other within the C-frame unit 11 by a support structure represented by the interposed metal bars 18a, 18b, 18c and 18d. Collectively, these bars form a holder 18 for the pairs of sources and detectors, holding the sources and detectors firmly in position within the unit 11, thus forming a unified structure, and disposing the sources and detectors in the correct orientation with respect to one another, as described below. The ‘C’ frame unit 11 has a lateral slot 20 of such a length that the radiation sources and detectors may traverse as a single unit completely across the sheet article 12 from one side to the other under the action of a drive mechanism (not shown) such as an electric motor and suitable drive train.

The radiation sources and detectors form three source-detector pairs 14a and 16a, 14b and 16b, and 14c and 16c. The sources and detectors of each pair are aligned and spaced from each other along a linear axis with a spacing or separation sufficient to accommodate the sheet article 12 between the sources and detectors so that radiation from each source passes through the sheet article and is detected by the corresponding detector. The alignment of the various pairs of sources and detectors is such that there is no mutual interference, i.e. the radiation produced by the source of one pair is not detected by the detector of either one of the other pairs.

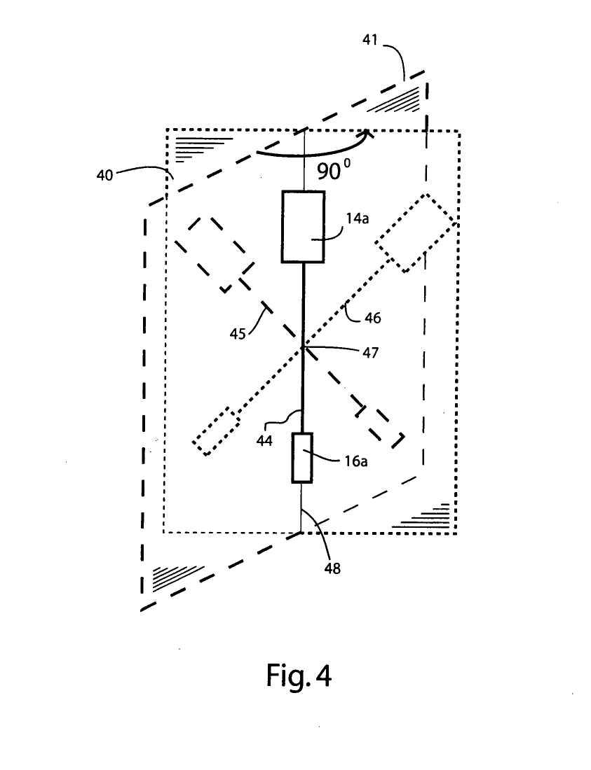

As illustrated rather simplistically in FIG. 4, it will be seen that the three pairs of radiation sources and detectors can be viewed as being disposed in two intersecting usually vertical planes 40 and 41 orientated at right angles to one another, such that one of the pairs (the vertical source and detector pair 14a-16a) is common to both planes at the line of intersection 48 of those planes. The detectable beams from the sources, i.e. beams 44, 45 and 46, cross or intersect at a common point 47. The planes are shown as intersecting at 90°. In fact, there may be a slight divergence from 90° without loss of undue accuracy. Thus, the angle may be 90°±5°, and more preferably 90°±1°.

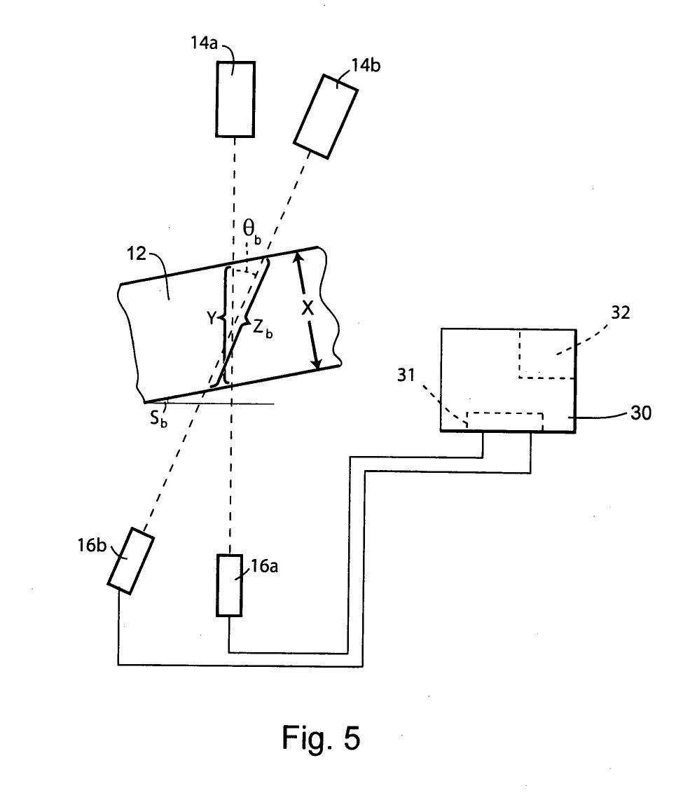

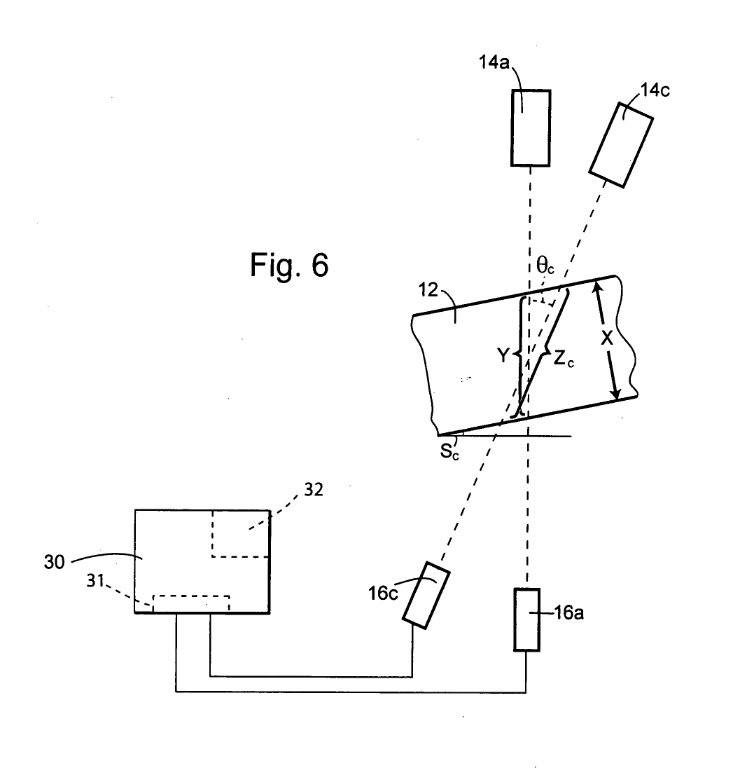

FIGS. 5 and 6 illustrate the manner in which the true thickness of a sheet article 12 may be measured at any point of measurement despite off-flatness (non-horizontal alignment) at that point.

When the sheet article 12 is advanced generally horizontally (its normal orientation), the source-detector pair 14a-16a is oriented generally vertically, i.e. at right angles to the direction of advancement and normal to the horizontal plane of the sheet article when flat and level. The source-detector pair 14b-16b is positioned in the same longitudinal vertical plane as the source-detector pair 14a-16a, i.e. a plane oriented in the rolling direction B of the sheet article, but its longitudinal axis is oriented at an angle to the vertical. The source-detector pair 14c-16c is positioned in a common vertical plane with the source-detector pair 14a-16a, i.e. a plane oriented transversely of the sheet article (direction A), but its longitudinal axis is oriented at an angle to the vertical. Of course, the angles of orientation of the three pairs of source-detectors with respect to each other are known and held constant by the holder bars 18a-18d shown in FIGS. 1 to 3.

The longitudinal axes of the three source-detector pairs are arranged such that the axes of all three pairs (and hence the detectable radiation beams from all three pairs) cross or intersect at a common point of intersection preferably positioned midway between each of the sources and detectors. Therefore, when the sheet article 12 is positioned centrally of the source and detector pairs, the three source-detector pairs are aligned to pass beams of radiation through a common central point within the body of the sheet article 12.

FIG. 5 shows a partial section in the vertical longitudinal plane of the sheet article and FIG. 6 shows a partial transverse section in the vertical transverse plane of the strip article 12. FIGS. 5 and 6 also show an apparatus 30 connected to the detectors 16a, 16b and 16c that may include a receiver 31 for output signals from the detectors, as well as a calculator 32 (e.g. computer) for calculating (from the output signals) the actual thickness and angle of slope of the strip article at the point of measurement. It should be noted that, although the ideal sheet article position is with the center line of the thickness at the intersection of the beams from the gauges, as stated, the sag and off-flatness will mean that the strip may be above or below this point of intersection at any given time. If necessary for even greater accuracy, this effect can be evaluated and corrected for in a computation of errors made by the calculator 32.

Inaccuracies of thickness measurement will occur if only one source-detector pair, e.g. 14a-16a, is used for the measurement because of the off-flatness (lateral sag or longitudinal lack of flatness) of the sheet article 12 at the point of measurement. For example, as shown in FIG. 5, the distance X (the true thickness of the strip) is measured by the radiation beam from source-detector pair 14a-16a only if the sheet article 12 is flat and orientated in a horizontal plane. If this is not the case, the source-detector pair measure the greater distance Y if the article slopes at an angle S_{b} to the horizontal in the rolling direction. However, when a beam from second source-detector pair 14b-16b is employed as well, this beam measures the distance Z_{b}. If thicknesses Y and Z_{b} are known from these two measurements (from the attenuation of the two beams as measured by the detectors 16a and 16b), and the angle θ_{b} between the beams is known (which is the case), the actual thickness X can be calculated. Basically, if the strip is horizontal in the transverse direction, thickness X is the value at which X is the same in the two equations below:

X=Y·cos(S_{b})

X=Z_{b}·cos(θ_{b}+S_{b})

### Thus, since Y and Z_{b} are the measured thicknesses and are thus known, and angle θ_{b} is known, X can be determined even if the angle S_{b} is not known.

For a similar cross-section taken in the transverse direction of the strip as shown in FIG. 6, the strip article is flat in the longitudinal direction but sags at an angle S_{c}, in the transverse direction, the actual thickness X can be calculated by

X=Y·cos(S_{c})

X=Z_{c}·cos(θ_{c}+S_{c})

Thus, by using three source-detector pairs simultaneously and with known mutual orientation, the true thickness X can be determined even if the strip is disposed at an angle to the horizontal in both the longitudinal and transverse directions, by solving the equations:

X=Y·cos(S_{b})·cos(S_{c})

X=Z_{b}·cos(θ_{b}+S_{b})·cos(S_{c})

X=Z_{c}·cos(θ_{c}+S_{c})·cos(S_{b})

It will be noted that, because the three source-detector pairs are angled around to a single point preferably within the strip article, the distance Y measured by the first (vertical) source-detector pair 14a-16a is the same for both the longitudinal and transverse calculations. However, there are two values of Z, i.e. Z_{b} and Z_{c}. Knowing the values of Y, Z_{b} and Z_{c}, and the angles θ_{b} and θ_{c}, it is possible solve X, S_{b} and S_{c} with a high level of accuracy.

As the movable unit 11 is traversed across the strip, the value of X, as well as the angles S_{b} and S_{c}, can be calculated at the frequency at which the detectors can detect a reliable signal, e.g. 0.1 seconds or less (preferably about 0.01 seconds).

The indicated apparatus can therefore eliminate measurement errors due to off-flatness distortions that are normally be present during the rolling of metal strip, especially aluminum sheet. The readings from the three source-detector pairs may be processed by the calculator (computer) in real time (or alternatively off-line) to give more accurate readings of sheet thickness at any point, as well as readings of flatness variation. The apparatus may be used to create sheet article profiles of thickness X and angles S_{b} and S_{c} at a variety of points on the sheet article. Moreover, the value of X across the strip width gives a measurement of the profile of the strip so that the operators of the mill may make corrections (manually or automatically) for the next coil or for the coil actually being measured. Similarly, the variation in the angles S_{b} and S_{c} gives a measurement of the sag and off-flatness of the strip so that the operators of the mill may make corrections (manually or automatically) for the next coil or for the coil actually being measured.

The invention may be applied to strip articles of any gauge provided the radiation may pass through and be detected with sufficient attenuation and signal strength for the determination of an accurate thickness measurement. Generally, the strip articles have a gauge between 1 to 50 mm, preferably 1 to 8 mm. The thicker gauges of strip article, e.g. 15 to 50 mm, may not be suitable for X-ray source-detector pairs because X-rays may not be powerful enough to penetrate fully; however, other sources of radiation may be employed, e.g. suitably shielded radioactive isotope sources and detectors (i.e. those employing ionizing radiation generated by suitable isotopes).

Virtually any strip article width can be accommodated, provided the source-detector pairs can be held in a fixed relationship to each other and to the strip article. Widths of 500 to 2500 mm are suitable, and more preferably 1000 to 2300 mm.

Scanning speeds of 0 to 2 m/s are preferred, and speeds of 0.5 to 1 m/s are even more preferable.

The angles at which the detector pairs are oriented to each other (i.e. angles θ_{b} and θ_{c}) may preferably range, for example, from 10 to 45°, more preferably 20 to 30°. These angles may be the same or different and can be selected to optimize the physical spacing of the source and detector elements on opposite sides of the strip article. The spacing of the source and detector elements from the surface of the strip article may also be chosen for optimal utilization of the apparatus, but may generally be within the range of 0.5 to 1 m.

Ideally, the environment within which the apparatus works is held at a fairly constant temperature to avoid errors caused by variations of temperature. Ideally, the temperature that the apparatus operates in is maintained at 25° C.±5° C.

The apparatus is generally able to detect sag (transverse) magnitudes of 0 to 100 mm, and more usually 0 to 50 mm, for example the center of a strip being 10 mm below the edges. In the case of strip flatness (longitudinal undulation) the detectable magnitude is generally 0 to 100 mm, and typically 0 to 20 mm, i.e. undulations oscillating as an approximate sine wave from a peak of +20 mm to a valley of −20 mm, with a form selected from long middle, wavy edge or quarter pockets (terms well-known in rolling technology).

Various speeds of movement of the strip article may be accommodated, depending on the frequency of thickness measurement achievable by the apparatus. Generally, speeds of 0 to 10 m/s, and more preferably 2 to 8 m/s, are suitable.

The invention is described in further detail with reference to the following Example.

### EXAMPLE

To demonstrate the advantage of the present invention, the inventors calculated the errors that would occur if the components of sag and manifest shape (off-flatness) were ignored in thickness measurements generated by conventional stereoscopic radiation sources and detectors.

Thus, the errors have been calculated as if there were no correction for the sag of the strip across the strip width and the slope in the rolling direction; also the error has been calculated if a correction were made for the sag across the width but not for the slope in the rolling direction.

Parameters used:

| | |
|---|---|
| Strip speed | 6 m/s |
| Strip width | 2 m |
| Scan speed | 0.5 m/s |
| Maximum sag | −20 mm |
| Maximum shape | 20 mm; peak to peak as |
| | long middle ±20 mm |
| Off-flatness wavelength | 2 m |
| Angle of stereoscopic detectors | 20° (in both directions) |
| Averaging time for scanning gauge | 10 ms. |

The sag has the form across the width that a beam would have simply supported at its ends and deflecting under its own weight.

The flatness has the form of long middle, modeled by taking the form of a beam deflecting under its own weight but built in at the ends (encastre).

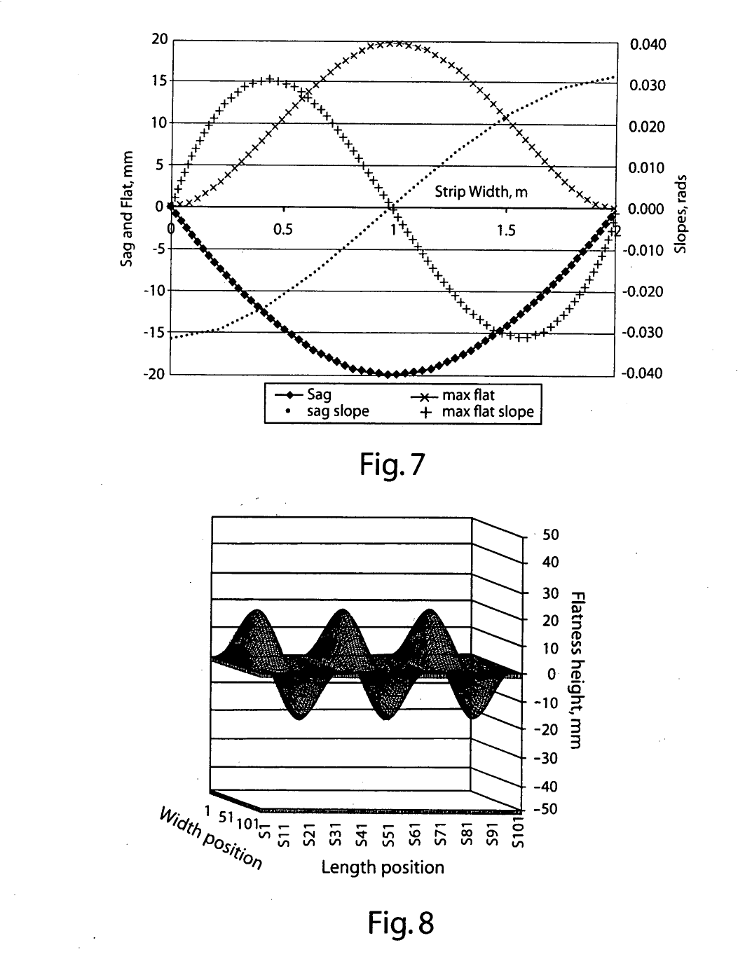

The form of these with the slope across the width is shown in FIG. 7. For a period of 2 seconds, the scan would cover half the width of the strip and at the strip speed scan a length of 12 m.

The manifest flatness along the length and across the width would have the appearance shown in FIG. 8.

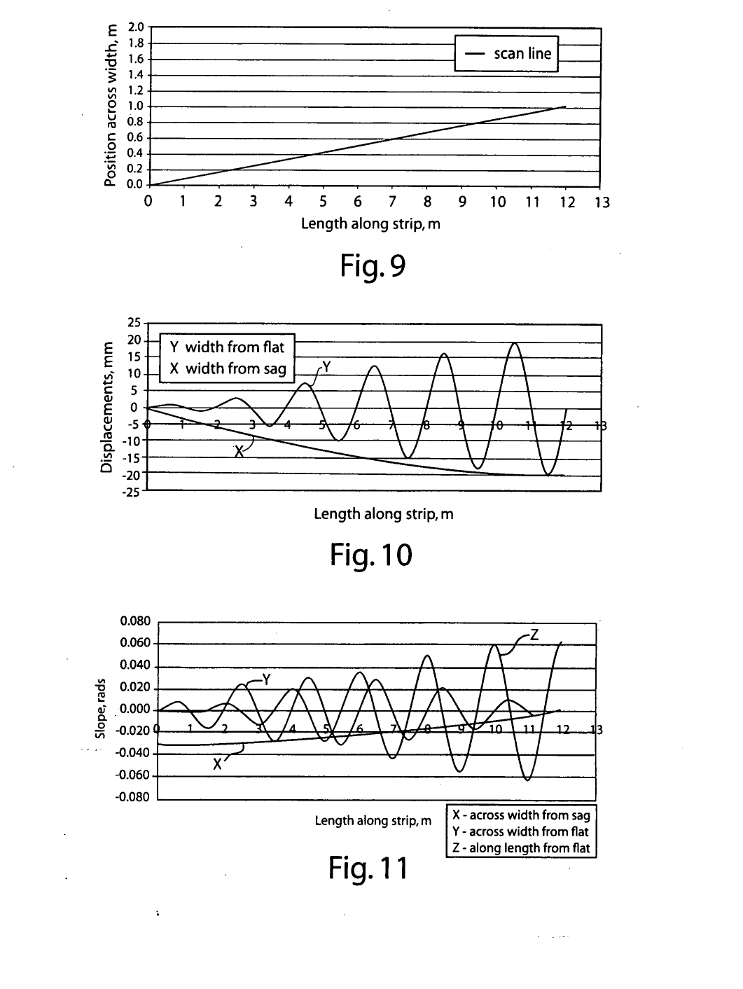

As the measurement takes place across the scan line (FIG. 9), the displacement of the strip and the slopes that the profile gauge would see in the across width and along the rolling direction are shown, respectively as independent effects in FIGS. 10 and 11 (FIG. 10 shows the displacements and FIG. 11 shows the slopes). Across the width the sag and flatness displacement and the slopes will combine to give an overall displacement and flatness.

Ignoring for the moment the error that would occur from the displacement of the strip in the vertical direction, which would mean that the beams of the angled detectors were not passing through the same piece of material, the ratio of the true thickness of the metal to the thickness that the vertical beam would see can be evaluated from the cosine of the slopes in the two directions.

If the combined slope of the sag and flatness across the width is taken into account and the slope in the rolling direction is assumed to be zero the ratio of true thickness to measured thickness is given by the cosine of the combined slopes (curves X and Y in FIG. 11).

If the slope in the rolling direction is taken into account (curve Z in FIG. 11), then the above number must be factored by the cosine of the slope in the rolling direction and this will then be the true correction needed in the thickness ratio.

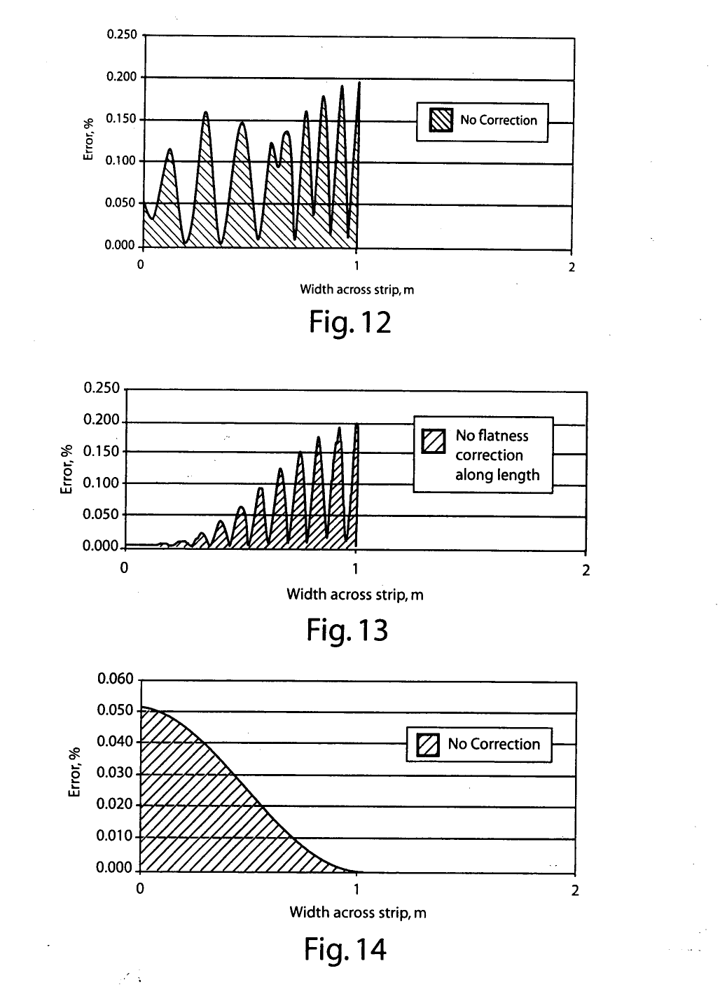

If no correction were to be made for sag or flatness on either direction then the assumption would be that the measured thickness was the correct thickness. The error in this assumption is plotted in FIG. 12 by taking the difference between the measured thickness in the vertical direction and the corrected thickness taking into account the slopes of the strip in both directions. The other half of the strip will have a symmetrical, mirror image, pattern of errors. The data is also corrected on the basis that the gauge would average the measurements over a 10 ms period, equivalent to 60 mm of strip length at the speed for these conditions.

If the sag and flatness is corrected for across the width direction but no flatness correction is made in the rolling direction, then the error that would be made in the thickness measurement would be as shown in FIG. 13. This would be the error if only a stereoscopic measurement was taken across the width and not in the rolling direction.

For the peak error that of close to 0.2% that is shown, this would represent the error in the measurement of profile that could occur as a result of this level of sag and off-flatness.

For any off-flatness, the peak error occurs at the centre of the scan (FIG. 13) with the same magnitude even if the sag and off flatness is corrected in the width direction but not in the rolling direction. This shows the importance of having the correction in the rolling direction as this is potentially the main source of errors in profile assessment if manifest off-flatness is present in the strip.

The error associated with displacement of the strip gives a correction to the position of the strip at which the angled detectors are measuring relative to the vertical detector. The maximum displacement of the strip in this case from the horizontal line is close to 40 mm near the centre of the strip. This would give a position error for the measurement of 40 tan(20°) or 14.6 mm in both the width and rolling direction.

A first order correction for the position of the measurement could be made in the computer system if this is found to be necessary. However the diameter of the collimated spot of an X-ray gauge is of a similar magnitude (40-50 mm) to the above value (14.6 mm) and the position error could be considered negligible.

If there is no manifest off flatness and only 20 mm of total sag then the error in thickness is as shown on FIG. 14 if no correction is made for the sag. The maximum error is 0.05%, which is acceptable thickness accuracy for profile measurement.

For a sag of 40 mm this increases to a thickness error of 0.2% which is too much error in the thickness measurement. The error is proportional to the square of the sag and is mainly affecting the edge error.

It would seem that if the sag could be restricted to 20 mm on 2 m wide or 10 mm on 1 m wide the correction for sag is very small.

As soon as manifest off-flatness appears, however, the correction in the width and length direction become important if the off-flatness exceeds ±10 mm on any width strip.

1. A method of determining an actual thickness of sheet article or angles of off-flatness at a point of measurement of the sheet article, which method comprises:
providing three pairs of sources and detectors of radiation capable of penetrating the sheet article, the source and detector of each pair being spaced from each other and aligned along a longitudinal axis,
disposing the three pairs of radiation sources and detectors in two intersecting planes orientated at 90°±5° to one another, such that one of the pairs is common to both planes at an intersection of the planes,
angling the respective pairs of radiation sources and detectors with respect to each other at known angles and such that the longitudinal axes of all three pairs intersect at a common point,
disposing a sheet article between the sources and detectors of each pair,
operating the radiation sources to generate radiation and to obtain an output value from the detectors of each pair corresponding to a detected thickness of the sheet article along each the axis; and
calculating an actual thickness or angles of off-flatness of the sheet article at the point of measurement from the values obtained from the three radiation detectors and from the known angles.

2. The method of claim 1, which comprises orienting said two intersecting planes at 90°×1°.

3. The method of claim 2, which comprises disposing the sheet article such that the common point falls preferably within the sheet article when the sheet is planar.

4. The method of claim 1, wherein sources and detectors of X-ray radiation are provided as said pairs.

5. The method of claim 1, wherein sources and detectors of ionizing radiation are provided as said pairs.

6. The method of claim 1, wherein, after performing the measurement for the position on the sheet article the aligned pairs of radiation sources and detectors are moved relative to the strip article and thickness measurements are carried out at another point of measurement on the sheet article.

7. The method of claim 6, wherein the relative moving and calculation is continued so that thickness measurements may be obtained at a plurality of points on the sheet article.

8. The method of claim 7, wherein the measurements at the plurality of points are compared to obtain an alignment profile of the sheet article at the points.

9. The method of claim 1, wherein the sheet article is elongated and is moved longitudinally between the sources and detectors of radiation.

10. The method of claim 9, wherein the pairs of radiation sources and detectors are moved transversely of the moving sheet article to calculate the thickness at a plurality of points across the sheet article.

11. A method of measuring a true thickness, as well as angles of off-flatness, of a moving strip article, which comprises:
providing a sheet article moving in a longitudinal direction;
generating three beams of sheet-article-penetrating radiation that cross at known angles at a common point of intersection;
disposing the beams and sheet article such that the beams pass through the strip article with one beam generally normal to the sheet article and the other beams respectively oriented in the longitudinal direction and a direction transverse to the longitudinal direction;
obtaining an indication of strength of the beams after passing through the sheet article at a point of measurement; and
calculating a true thickness of the article at the point of measurement and additionally angles of off-flatness of the strip article in the longitudinal and transverse directions.

12. A method of measuring thickness or off-flatness of an elongated strip article as said strip article is being advanced longitudinally in a direction of advancement, which method comprises passing penetrating radiation through the strip article, measuring attenuation of the radiation passing through the strip article, and calculating the thickness or off-flatness of the strip article from the measured attenuation, wherein attenuation of three beams of said radiation intersecting at a common point is measured at the same time, a first of said beams being disposed generally at right angles to the direction of advancement, a second beam being rotated at an angle to the first beam in the direction of advancement of the strip article and a third beam being rotated at an angle to the first beam in a direction transverse to the direction of advancement of the strip article.

13. Apparatus for determining an actual thickness of a sheet article and angles of off-flatness at a point of measurement thereof, the apparatus comprising:
three pairs of sources and detectors of radiation capable of penetrating the sheet article, the source and detector of each pair being spaced from each other along a longitudinal axis,
the three pairs of radiation sources and detectors being disposed in two intersecting planes orientated at right angles to one another, such that one of the pairs is common to both planes at an intersection of the planes,
the three pairs of radiation sources and detectors being angled with respect to each other at known angles and such that the longitudinal axes of all three pairs intersect,
a holder for holding the three pairs of radiation sources and detectors with the sources and detectors disposed on opposite sides of a sheet article positioned between the sources and detectors of each pair,
a receiver for receiving output values from the detectors of each pair corresponding to a detected thickness of the sheet article along each the axis; and
calculator for calculating an actual thickness of the sheet article and angles of off-flatness at the point of measurement from the output values received from the three radiation detectors and from the known angles.

14. The apparatus of claim 13, wherein the three pairs of radiation sources and detectors are angled such that the axes intersect at a common point between each of the sources and detectors.

15. The apparatus of claim 14, wherein the sheet article is disposed such that the common point falls within the sheet article, at least in parts of the sheet article that are planar.

16. The apparatus of claim 13, wherein the holder has a structure that allows the radiation sources and detectors to be moved transversely fully across the sheet article.

17. The apparatus of claim 13, wherein the radiation sources and detectors are sources and detectors of X-ray radiation.

18. The apparatus of claim 13, wherein the radiation sources and detectors are sources and detectors of ionizing radiation.

19. The apparatus of claim 13, wherein the calculator is a computer.

20. The apparatus of claim 13, wherein the calculator is capable of recording thickness measurements at various measurement points and of generating a thickness and an alignment profile of the sheet article at the points.

21. Apparatus for measuring thickness or off-flatness of a strip article as said article is being advanced longitudinally in a direction of advancement, said apparatus including aligned pairs of sources and detectors of penetrating radiation positioned to measure attenuation of beams of radiation passing through the strip article, and a calculator for calculating thickness or off-flatness of the strip article from the measured attenuation, wherein the apparatus has three pairs of said sources and detectors positioned and operable to measure attenuation of three beams radiation intersecting at a common point at the same time, a first pair disposed generally at right angles to the direction of advancement of the strip article, a second pair being rotated at an angle to the first pair in the direction of advancement, and a third pair being rotated at an angle to the first pair in a direction transverse to the direction of advancement of the strip article.
